(19) United States
(12) Patent Application Publication
(10) Pub. No.: US 2017/0344631 A1
(43) Pub. Date: Nov. 30, 2017

(54) TASK COMPLETION USING WORLD KNOWLEDGE

(71) Applicant: Microsoft Technology Licensing, LLC., Redmond, WA (US)

(72) Inventors: Srinivasa Varadhan Thirumalai-Anandanpillai, Hyderabad (IN); Nishchay Kumar, Delhi (IN); Sravanth Venkata Madhu Kurumaddali, Hyderabad (IN); Sasanka Madiraju, Hyderabad (IN); Vipindeep Vangala, Hyderabad (IN)

(73) Assignee: Microsoft Technology Licensing, LLC., Redmond, WA (US)

(21) Appl. No.: 15/166,124

(22) Filed: May 26, 2016

(51) Int. Cl. G06F 17/30

(52) U.S. Cl. CPC G06F 17/30696; G06F 17/30684; G06F 17/30876

(57) ABSTRACT

Automatic enrichment of a data collection with contextually relevant activity/intent suggestions for task completion is provided. The system extracts data from a data collection, identifies one or more intents associated with the data collection, structures the data collection into one or more meaningful groupings, and determines and provides contextually relevant suggestions for task completion for display in a user interface. The contextually relevant suggestions can be augmented in the data collection or surfaced at contextually relevant times on various output surfaces or on various computing devices.

### BACKGROUND

Computer users oftentimes generate and store various collections of heterogeneous sets of data, such as documents, text snippets, to-do lists, uniform resource locators (URLs) of websites visited. Such collections may be aggregated via a variety of frameworks, may include organized or unorganized content, and may be stored across a plurality of repositories. Typically, intents of a user, the user's tasks, and the user's activities are encapsulated in these collections of data. For example, if a user is planning to purchase a camera, the user may browse various web pages related to various cameras, collect notes related to cameras using one or various applications, receive or send emails relating to cameras, etc. The user has to keep track of the information he/she has collected; and when ready to analyze the data or make the purchase, the user has to locate and manually analyze the collected information.

### SUMMARY

This summary is provided to introduce a selection of concepts in a simplified form that are further described below in the Detailed Description section. This summary is not intended to identify all features of the claimed subject matter, nor is it intended as limiting the scope of the claimed subject matter.

Aspects are directed to a device, method, and computer-readable medium for increasing task completion efficiency by providing automatic enrichment of a data collection with contextually relevant activity/intent suggestions for task completion. For example, when a user uses an application to create an implicit or explicit group of content, which can be a heterogeneous set of data including URLs, to-do items, documents, images, etc., the system receives and analyzes the data collection to identify an entity of interest associated with the data collection, which may include identifying a person, place, object, etc., and identifies tasks associated with the entity of interest for determining an intent on the data collection. Further, the system analyzes corpuses of data for identifying tasks that are associated with a particular entity type or intent, as well as task providers that are operative to help complete the tasks. In response to identifying tasks to achieve an intent or activity and task providers, the system creates an activity completion template comprising a sequence of the tasks and identified task providers.

Additionally, the system learns constraints associated with the data collection to query one or more data sources for identifying related content in view of the identified entity and learned constraints. For example, related content may include information about the entity, related entities, information about related entities, etc. In response to identifying tasks and related content, the system displays an application user interface comprising the data collection, which is modified to display the tasks, task providers, and related content appended to the data collection data. Accordingly, task completion efficiency is increased by automatically providing related content relevant for task completion.

Additionally, aspects are directed to improving user interaction efficiency by automatic organization of one or more unorganized data collections based on reasoning on top of the one or more data collections. For example, user interaction efficiency is improved by identifying one or more intents of one or more data collections, and structuring content into logical groupings based on the identified intent(s).

The details of one or more aspects are set forth in the accompanying drawings and description below. Other features and advantages will be apparent from a reading of the following detailed description and a review of the associated drawings. It is to be understood that the following detailed description is explanatory only and is not restrictive; the proper scope of the present disclosure is set by the claims.

### BRIEF DESCRIPTION OF THE DRAWINGS

The accompanying drawings, which are incorporated in and constitute a part of this disclosure, illustrate various aspects of the present disclosure. In the drawings:

FIG. 1A illustrates a block diagram of a system enabled to provide automatic enrichment of a data collection with contextually relevant activity/intent suggestions;

FIG. 1B illustrates a simplified block diagram showing various components of the reasoning engine;

FIG. 2 illustrates various example data collections;

FIG. 3 illustrates example learned constraints on a data collection;

FIGS. 4A-D illustrate example user interfaces for displaying related interesting information and suggestions;

FIG. 5 is a flowchart showing general stages involved in an example method for providing automatic enrichment of a data collection with contextually relevant activity/intent suggestions;

FIG. 6 is a block diagram illustrating physical components of a computing device with which examples may be practiced;

FIGS. 7A and 7B are block diagrams of a mobile computing device with which aspects may be practiced; and

FIG. 8 is a block diagram of a distributed computing system in which aspects may be practiced.

### DETAILED DESCRIPTION

The following detailed description refers to the accompanying drawings. Wherever possible, the same reference numbers are used in the drawings and the following description to refer to the same or similar elements. While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the present disclosure, but instead, the proper scope of the present disclosure is defined by the appended claims. Examples may take the form of a hardware implementation, or an entirely software implementation, or an implementation combining software and hardware aspects. The following detailed description is, therefore, not to be taken in a limiting sense.

Aspects of the present disclosure are directed to a device, method, and computer-readable medium for increased task completion efficiency by automatic supplementation of a data collection with relevant content for task completion. For example, a user may have various collections of heterogeneous sets of data that are stored across various repositories. The various collections of data may include URLs of web pages that the user has viewed, documents that the user has authored, text snippets or to-do lists created by the user, emails or text messages created by or sent to the user, etc. Typically, a user's intents, tasks, and activities are encapsulated in such collections of data.

Consider, for example, the user is planning an upcoming trip to Seattle. Information related to Seattle, related to travelling to Seattle, or related to travelling in general may be included in one or more collections of data associated with the user. The user's browsing history may include websites related to Seattle, such as places to stay, places to visit, things to do, etc. Additionally, the user may create to-do lists including tasks related to preparing for travel (e.g., purchase airline tickets, book hotel, stop mail delivery, hire a pet sitter). Further, the user may have various emails and text messages related to the trip (e.g., itineraries, reservation information, suggested places to visit from friends).

The system receives and analyzes a data collection to identify one or more entities associated with the data collection, and to determine a dominant entity of interest. For example, the entity of interest in the above example may be determined to be Seattle. Further, the system learns constraints for determining an intent associated with the data collection and for identify related content. For example, if a data collection includes a listing of points of interest in Seattle, such as a museum, a park, quiet drives, etc., the system may detect a constraint as places that are quiet or peaceful, and utilize the learned constraint as a rule for querying an external data source for other quiet or peaceful points of interest in or near Seattle to suggest to the user.

Further, the system identifies tasks associated with the entity of interest for determining an intent on the one or more data collections. For example, the system may identify various tasks in the user's to-do items, such as purchase airline tickets, book a hotel, stop mail delivery, reserve a car, hire a pet sitter, etc., and determine that the tasks on the Seattle entity of interest are related or directed to travel. Thus the intent of the data collection may be determined to be travelling to Seattle. As another example, if the data collection includes a to-do item, such as “book cheap flight tickets to Seattle,” the system may use natural language processing to extract tasks, subjects, objects, or constraints from the item, which the system is operative to use for identifying the user's intent, and accordingly for identifying tasks for achieving the intent.

In addition, the system analyzes corpuses of data for identifying context words, tasks that are associated with a particular entity type or intent, or to a specific entity, as well as task providers that are operative to help complete the tasks. For example, for a location entity type, the system may identify the following tasks that individuals perform based on click data, for example, from a search engine or other signal source, to associate with a data collection including a location-related intent: find weather, look maps, book hotels, get real estate, find jobs, see classifieds, read news, restaurants, libraries, schools, public records, videos, images, things to do, shopping, movies at places, etc. Further, the system is enabled to determine popular task providers for each task based on community data from a plurality of users or on a user's personal data. For example, a popular task provider for a find weather task may be a particular weather website or weather application.

In response to identifying tasks to achieve an intent or activity and task providers, the system creates an activity completion template comprising a sequence of the tasks and identified task providers, which can be curated or learned from browsing/search history data or other signals. Further, the system queries one or more data sources for identifying related content in view of the identified entity and learned constraints. For example, the system may identify other museums, parks, spas, yoga studios, etc., based on learned constraints. The system displays an application user interface comprising the data collection, which is modified to display the tasks, task providers, and related content appended to the data collection data. Thus, task completion efficiency of a user is increased by automatically supplementing a data collection with additional information for completing user-defined tasks as well as suggested tasks based on an identified intent. For example, by automatically providing additional information for task completion, manual searching for relevant information related to task completion can be reduced or eliminated.

Further, the system organizes an unorganized data collection, and links a plurality of data collections based on an identified related intent. Accordingly, user interaction efficiency is improved by automatically organizing and linking related content.

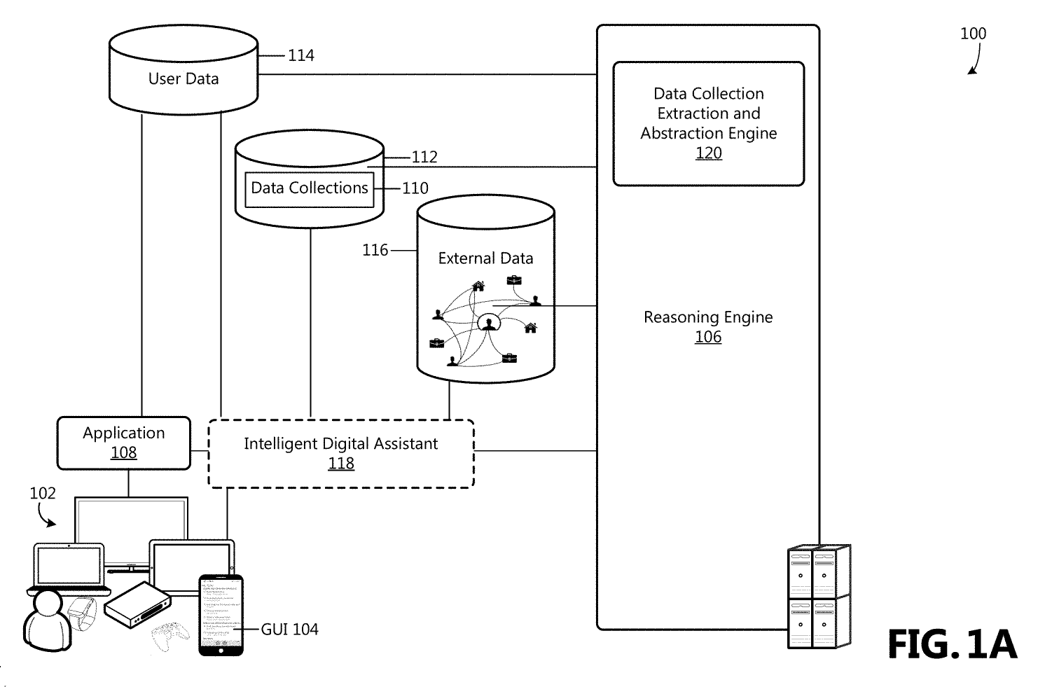

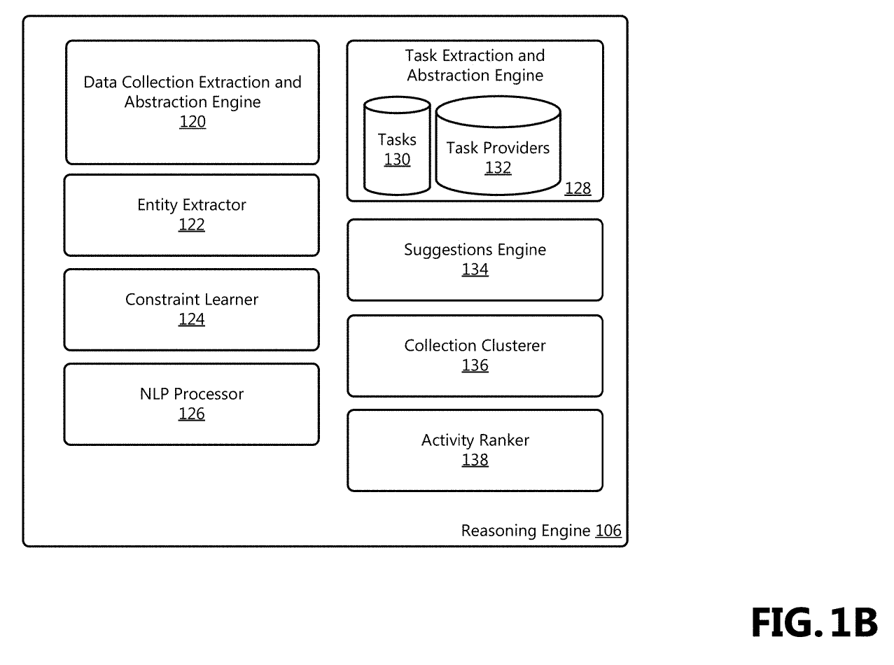

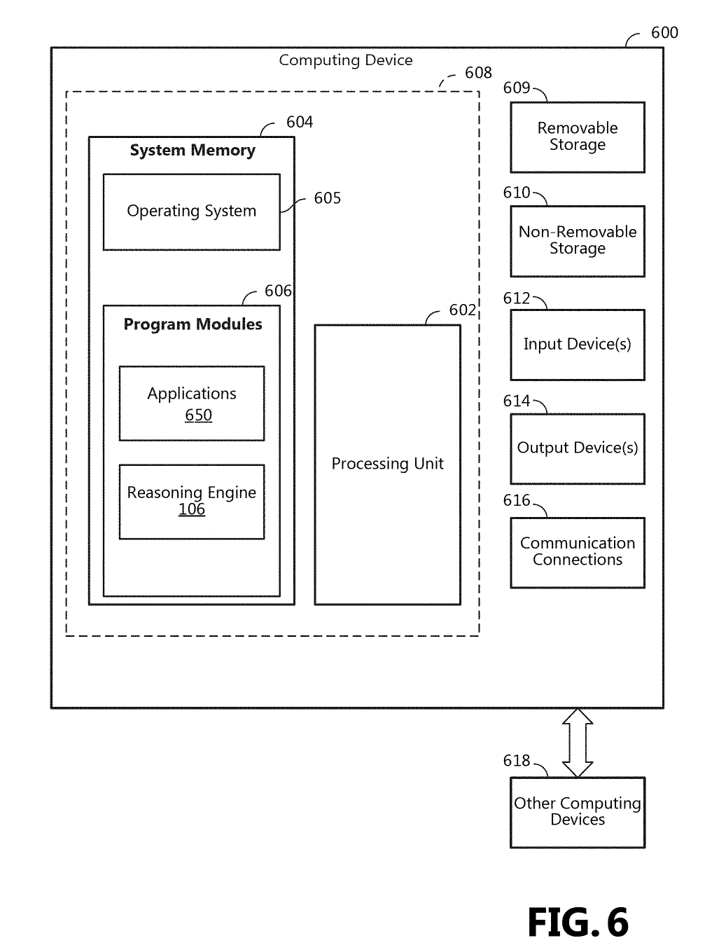

FIG. 1A illustrates a simplified block diagram of a representation of a computing environment 100 for improving user interaction efficiency and increasing task completion efficiency of a user by automatically structuring tasks and proactively providing recommendations based on an identified intent of one or more collections of data associated with the user. As illustrated, the example environment includes a computing device 102 executing an application 108. The computing device 102 may be one of various types of computing devices (e.g., a tablet computing device, a desktop computer, a mobile communication device, a laptop computer, a laptop/tablet hybrid computing device, a large screen multi-touch display, a gaming device, a smart television, a wearable device, a connected automobile, a smart home device, or other type of computing device) for executing applications 108 for performing a variety of tasks. The hardware of these computing devices is discussed in greater detail in regard to FIGS. 6, 7A, 7B and 8.

A user may utilize applications 108 on the computing device 102 for a variety of tasks, which may include, for example, to write, calculate, draw, take and organize notes, organize, prepare presentations, send and receive electronic mail, browse web content, make music, and the like. Applications 108 may include thick client applications 108, which may be stored locally on the computing device 102, or may include thin client applications 108 (i.e., web applications) that reside on a remote server and accessible over a network, such as the Internet or an intranet. A thin client application 108 may be hosted in a browser-controlled environment or coded in a browser-supported language and reliant on a common web browser to render the application 108 executable on the computing device 102. According to examples, a graphical user interface (GUI) 104 is provided for enabling the user to interact with functionalities of the application 108 through manipulation of graphical icons, visual indicators, and the like, and for creating, viewing, and editing one or more data collections 110.

According to an example, a data collection 110 is a grouping of content that comprises one or more present or embedded data objects including, but not limited to: text (including text containers), numeric data, URLs, to-do items, documents, images, movies, sound files, and metadata. Content in a data collection 110 may be organized, such as a music collection, or may be unorganized, such as a user's browsing history, free-form information (e.g., users' notes, drawings, screen clippings, audio commentaries), etc. According to an aspect, content in a data collection 110 may vary according to the application 108 used to create the data collection 110.

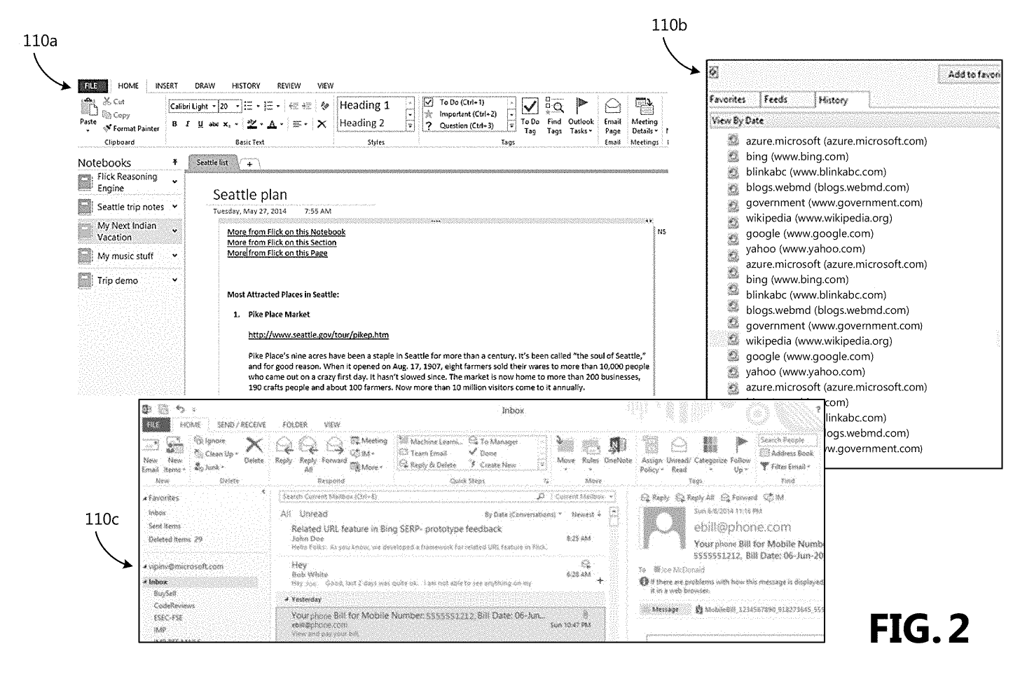

Some data collection 110 examples are illustrated in FIG. 2. For example, a first example data collection 110a is embodied as a free-form information collection, such as a free-form information collection created using a digital notebook application. This example of a data collection may be considered as an explicit collection created by a user in view of a certain intent. For example, if the user is planning an upcoming trip to Seattle, the free-form information collection may comprise such information as a to-do list of items in preparation for the trip, a listing a places to visit, etc. The free-form information collection may include various data elements, such as digital handwriting, blocks of text, images, audio clips, etc. In some examples, a free-form information collection may be converted into a hierarchical collection. For example, a top level of the free-form information collection may comprise a notebook, a next level may comprise a set of sections, wherein each section may comprise multiple pages, and each page may be subdivided into multiple nodes, such as paragraphs, to-dos, bullet points, and the like.

A second example data collection 110b illustrated in FIG. 2 is embodied as a user's browsing history, and a third example data collection 110c is embodied as an email. These examples of data collections may be considered as implicit collections. For example, a user's browsing history, a user's emails or other electronic communications may typically be organized via a timeline rather than by specific content type groupings. Data collections 110 may be stored in a single data repository 112 or across various data repositories 112.

In some examples, data comprising the content in a data collection 110 is stored in an elemental form by an electronic document, such as in Extensible Markup Language (XML), Java Script Object Notation (JSON) elements, HyperText Markup Language (HTML), or another declaratory language interpretable by a schema. The schema may define sections or content item via tags and may apply various properties to content items via direct assignment or hierarchical inheritance. For example, an object comprising text may have its typeface defined in its element definition (e.g., “<text typeface=garamond>example text</text>”) or defined by a stylesheet or an element above the object in the document's hierarchy from which the element depends.

With reference again to FIG. 1A, an application 108 includes or is in communication with a reasoning engine 106, operative to provide automated structuring of tasks and supplementation of recommendations based on an identified intent and relevant content for task completion. In one example, the computing device 102 includes a task reasoning application programming interface (API), operative to enable the application 108 to employ the reasoning engine 106 via stored instructions. In one example, the reasoning engine 106 is in communication with one or more external data sources 116, wherein querying the one or more external data sources 116 for related interesting information and relevant content for task completion may be performed utilizing a search engine, a knowledge graph or a database.

In an example, the computing device 102 includes or is in communication with an intelligent digital assistant 118. For example, the intelligent digital assistant 118 is illustrative of a software module, system, or device operative to perform such tasks as: set reminders, recognize natural voice without the requirement for keyboard input, answer questions using external data 116 via a search engine, search for files on the computing device 102 or in storage repositories in communication with the computing device 102, such as data repository 112, perform calculations and conversions, track flights and packages, check the weather, set alarms, launch applications, send messages, create calendar events, and the like. According to an aspect, the intelligent digital assistant 118 is operative to timely suggest contextually relevant content for task completion, wherein the contextually relevant content includes information such as: a sequence of tasks that are determined to achieve an activity, a data collection 110 determined to be contextually relevant, other interesting relevant information. Contextual relevance may be determined based on one or more of: temporal data, location data, proximity data, etc. For example, temporal data can be obtained by a date/time-determining component or service that exists on the user's computing device 102 or accessible thereto. As another example, location data can be obtained from a GPS sensor or other location-determining component or service (e.g., Bluetooth®, wireless, cellular, or other connections). As another example, a user's proximity to other people or objects can be determined using, for example, a Bluetooth® (or similar technology) interface, a camera and/or microphone of user's computing device 102, or may be inferred from a wide variety of other sensors or signals. For example, the user may have a data collection 110 related to the user's trip to Seattle. Upon detecting that the user is in Seattle, the intelligent digital assistant 118 may automatically provide such relevant content as: the data collection 110 related to Seattle for display to the user in the GUI 104, suggest interesting sightseeing places, provide a weather report, suggest and assist with purchasing tickets for a performance for a particular artist of interest to the user in Seattle, etc. According to an example, the relevant content is determined by the reasoning engine 106 and communicated to the intelligent digital assistant 118.

According to examples, the reasoning engine 106 includes a data collection extraction and abstraction engine 120, illustrative of a software module, system, or device operative to extract a data collection 110 from a data repository 112 associated with a particular user. The data collection extraction and abstraction engine 120 is communicatively attached to one or more data repositories 112 associated with the user, for example, one or more data repositories 112 comprising the user's notes, browsing history, text messages, emails, etc. In one example, a data collection 110 is published to the reasoning engine 106 using a plugin.

Further, the data collection extraction and abstraction engine 120 is communicatively attached to a repository comprising user-specific data 114. User-specific data 114 may be stored in a single repository or across a plurality of repositories. In one example, the repository is a backend personal information repository comprising information relating to the user, such as calendar events, user preference data, etc., to provide relevant contextual information that is applicable to a particular scenario for determining or prioritizing suggestions or recommendations to the user.

According to an example, when a data collection 110 is an unorganized collection, the data collection extraction and abstraction engine 120 is further operative to convert the data collection 110 into a hierarchical collection. For example, a user may create a data collection 110 embodied as a notebook using a notes-taking application 108, such as EVERNOTE, ONENOTE, SIMPLENOTE, GOOGLE KEEP, APPLE NOTES, or other notes-taking application. The data collection extraction and abstraction engine 120 converts the data collection 110 into a hierarchical collection, wherein a top level is a notebook, a next level is a set of section, and then each section comprises one or more pages. Each page may be subdivided into multiple nodes, such as paragraphs, to-do's, bullet points, etc. Accordingly, the data collection extraction and abstraction engine 120 upscales the data collection 110, and creates structured data out of the collection. For example, a hierarchical collection can be used to transform various types of data (e.g., notes, emails, browsing history, messages) into an abstraction.

With reference now to FIG. 1B, a simplified block diagram showing various components of the reasoning engine 106 is illustrated. According to an aspect, to help identify an intent of the user's data collection 110, the reasoning engine 106 includes an entity extractor 122, illustrative of a software module, system, or device operative to identify one or more entities of interest. In an example, the entity extractor 122 utilizes a natural language processor 126 to parse the data collection 110 and extract tasks, subjects, objects, constraints, etc., from any natural language data (e.g., to-do's, text messages, paragraphs, query). For example, from a query or a to-do list item such as “book cheap flight tickets to Seattle,” the natural language processor 126 may abstract the following information: “booking,” “flight,” “Seattle,” and “cheap,” from which a task, subject, an object, and constraints can be identified (e.g., task=“booking,” subject=“flight,” object=“Seattle,” and constraints=“cheap”).

In another example, the entity extractor 122 uses URL processing to parse data in an external data source 116 addressed by a URL included in the data collection 110. For example, the data collection 110 may include a link to a webpage. Accordingly, the entity extractor 122 may utilize URL processing to parse the contents of the webpage and utilize a knowledge graph for understanding the contents of the webpage, and determine one or more entities of interest. In another example, the entity extractor 122 uses document processing for reasoning on top of the natural language paragraphs for determining one or more entities of interest.

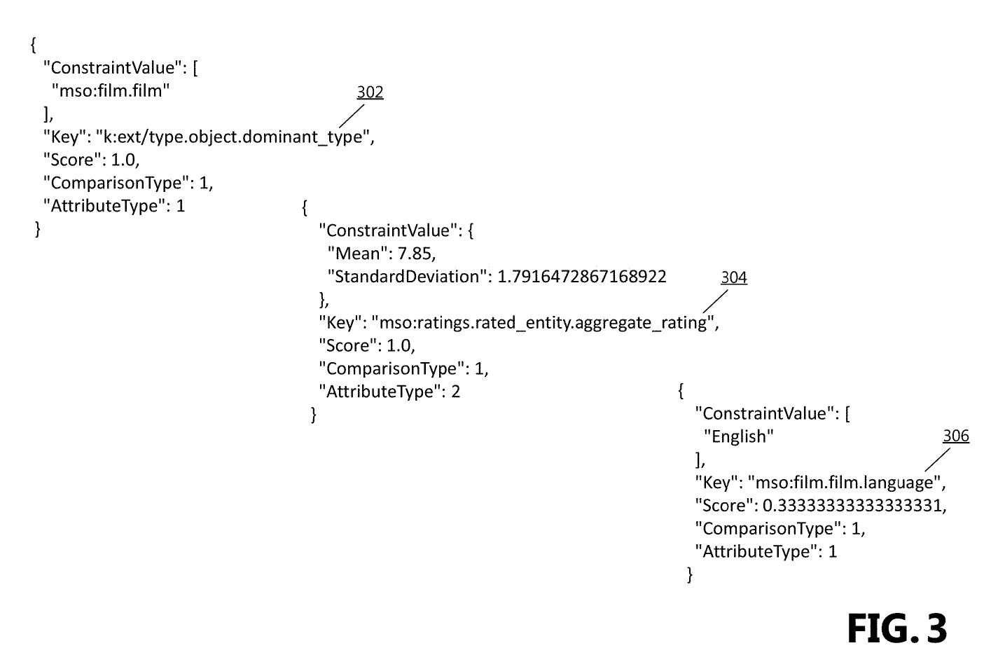

According to an aspect, the reasoning engine 106 includes a constraint learner 124, illustrative of a software module, system, or device operative to use context in a data collection 110 to learn constraints for querying an external data source 116 for identifying related content. For example, a user may have a data collection 110 comprising a listing of several movies. Upon extraction of the movies from the data collection by the entity extractor 122, the constraint learner 124 may make one or more comparisons based on one or more attributes, and learn one or more constraints 302, 304, 306. For example and with reference to FIG. 3, the constraint learner 124 may perform a first constraint learning operation identifying a first constraint 302 as a movie type object, for example, that each of the entities is a movie. The constraint learner 124 may perform a next constraint learning operation identifying a rating constraint 304, for example, that each of the movies is a relatively highly rated movie with an average rating of 7.85. The constraint learner 124 may perform a next constraint learning operation identifying an English language constraint 306, for example, that all of the movies are English language movies. The constraint learner 124 may perform additional operations to learn additional constraints, such as a common genre, common actors, common producers, etc. Accordingly, such constraints can be utilized to search for finding and suggesting other movies that have similar attributes.

As another example, if a collection is about mobile phones and includes information about two specific mobile phone types, the constraint learner 124 is operative to detect such constraints as the brand of the two mobile phone types, that both mobile phone types have high megapixel camera, have a battery charge of around 2000 mAh with a variance of 100, offer high definition recording, etc. Accordingly, such constraints can be utilized to search for other mobile phones with similar specifications.

According to an aspect, the reasoning engine 106 includes a task extraction and abstraction engine 128, illustrative of a software module, system, or device operative to algorithmically learn a set of tasks based on an intent or activity. For example, the task extraction and abstraction engine 128 is in communication with one or more external data sources 116, and identifies tasks and context words associated with an intent. For example, context words can be utilized for natural language processing. In one example, the task extraction and abstraction engine 128 identifies tasks and context words based on search engine knowledge graph data. In another example, the task extraction and abstraction engine 128 identifies tasks and context words based on search engine activity sessions. According to an example, the task extraction and abstraction engine 128 applies statistical methods and temporal association rule mining algorithms on community browsing logs.

As an example, for a theater or play-related intent or activity, the task extraction and abstraction engine 128 may extract such associated tasks as: tickets, summary, characters, reviews, videos, cast, images, quotes, script, writer, apparel, quizzes, songs, etc. As another example, for a location-related intent or activity, the task extraction and abstraction engine 128 may extract the following associated tasks: find weather, look maps, book hotels, get real estate, find jobs, see classifieds, read news, restaurants, libraries, schools, public records, videos, images, things to do, shopping, movies at places, etc.

According to an aspect, the task extraction and abstraction engine 128 is further operative to apply entity-specific learning for identifying tasks associated with an intent or activity. As an example, the task extraction and abstraction engine 128 is operative to identify specialized tasks associated with specific entities, such as a specific place (e.g., New York, Las Vegas, Orlando, Seattle).

According to an aspect, the task extraction and abstraction engine 128 is further operative to learn algorithmic task timelines, for example, a chronological task time line to complete an activity or intent. For example, a learned task timeline for planning a trip may include the following tasks in a chronological order: books flight tickets, hotels, weather, sight-seeing, etc. In one example, the task extraction and abstraction engine 128 learns task timelines via analyzing browsing session data, and understanding association rules between tasks and chronological ordering through temporal association rule mining. The task extraction and abstraction engine 128 stores known tasks and task timelines in a task repository 130.

Further, the task extraction and abstraction engine 128 is operative to determine how to accomplish learned tasks, for example, to identify popular task providers that are able to help complete tasks. For example, based on one or more external data sources 116, such as click data, the task extraction and abstraction engine 128 may identify a popular task provider for a find weather task to be a particular weather website or weather application. Click data may be from a search engine or other signal source. The task extraction and abstraction engine 128 stores the known task providers in a task providers repository 132.

According to an aspect, the reasoning engine 106 comprises a suggestions engine 134, illustrative of a software module, system, or device operative to provide suggestions to the user to help the user to complete a task. In one example, the suggestions engine 134 provides suggestions, such as entity information, related entities, related articles, etc., based on identified entity/entities, an identified intent, and learned constraints on a data collection 110. For example, the suggestions engine 134 is operative to query one or more external data sources 116 for related interesting information and relevant content.

In another example, the suggestions engine 134 is operative to infer the activity/activities that are intended in a data collection 110, and provide an activity completion template comprising a set of known tasks and task providers. According to one example, the suggestions engine 134 is operative to provide tasks based on the context of a data collection 110. For example, if the intent of a data collection 110 is identified as “travel to Seattle,” there may be a large number of different tasks that people perform for general places. However, based on context, the suggestions engine 134 is operative to suggest a subset of correlated tasks based on the context of the data collection 110. Based at least in part on tasks identified and extracted from a data collection 110, an intent of the data collection 110 is identified, and the suggestions engine 134 queries the task repository 130 and the task providers repository 132 for known tasks and task providers that are associated with the identified intent. In some examples, the suggestions engine 134 is operative to prioritize certain task providers based at least in part on user data 114. For example, the task extraction and abstraction engine 128 is operative to prioritize certain tasks or task providers based on user (personal) data 114, such information as user preferences, user memberships, awards programs to which the user belongs, etc.

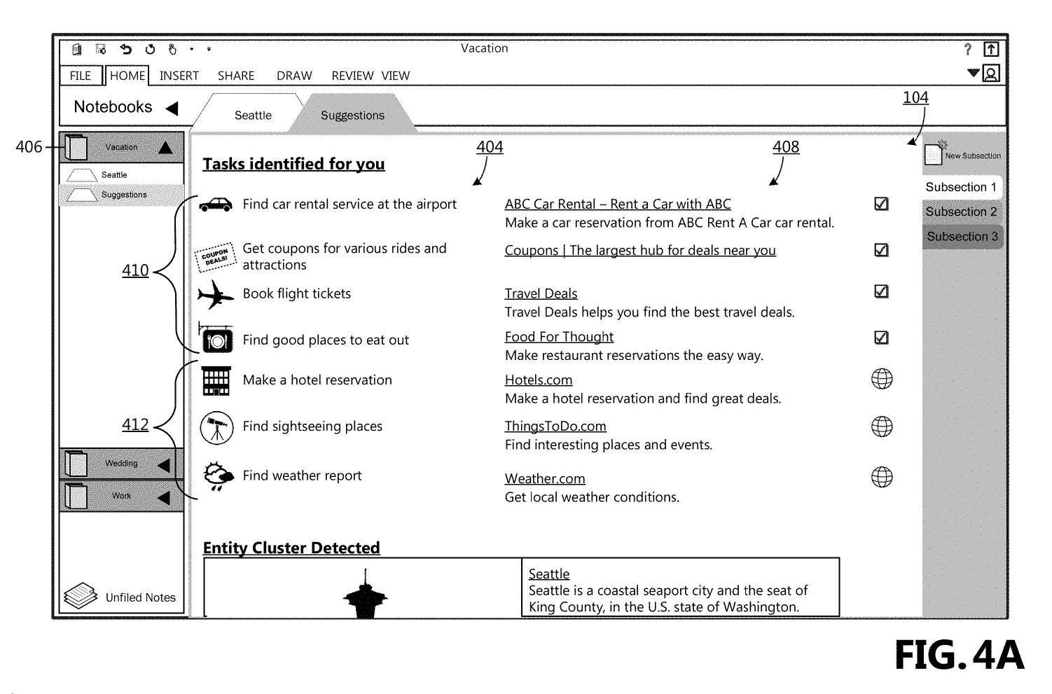

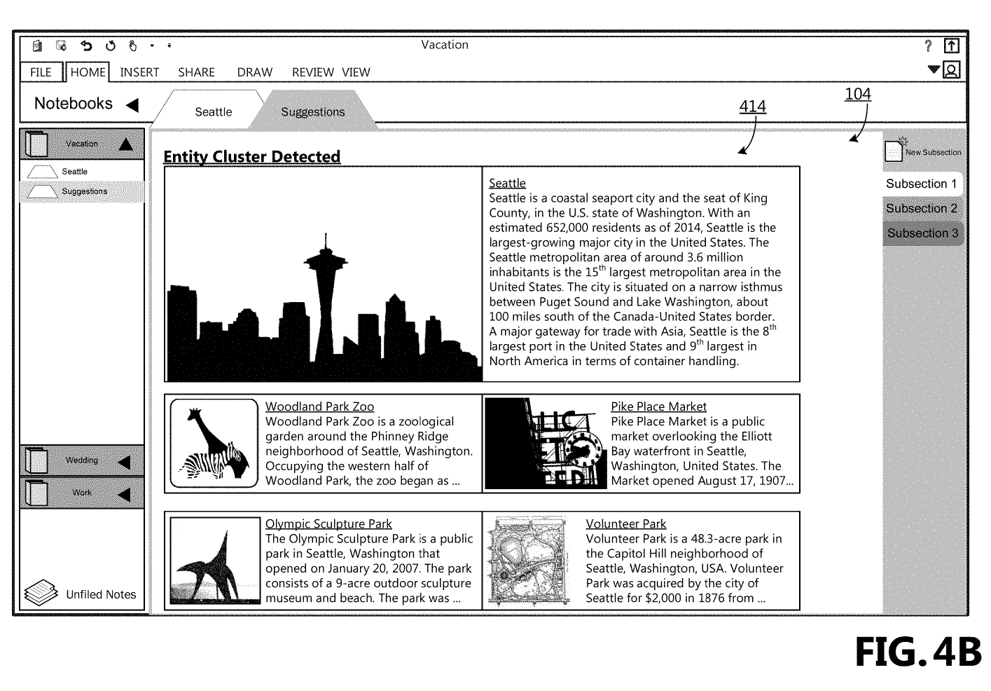

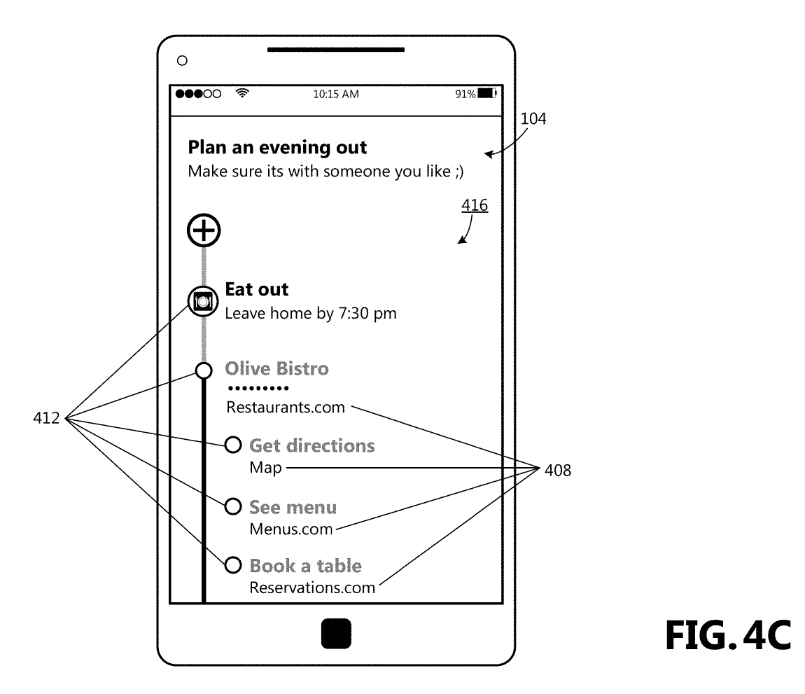

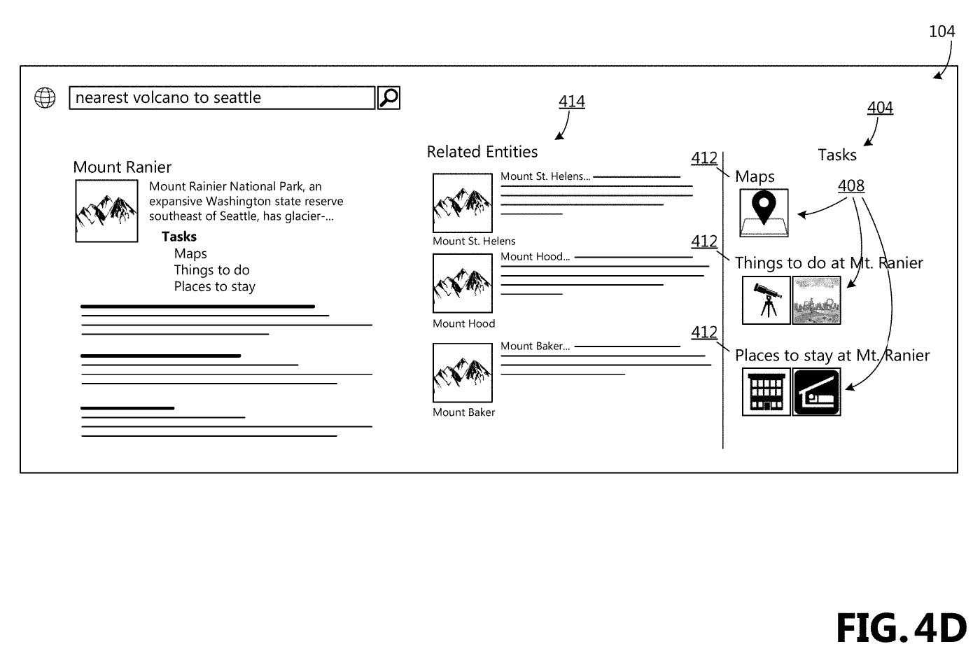

For example and as illustrated in FIG. 4A, an example graphical user interface 104 including a display of a list of tasks 404 identified for a user is provided. According to an aspect and as illustrated, a list of tasks 404 may include one or more tasks explicitly specified by the user. For example, the user may create a list comprising one or more to-do items, which may be extracted by the system and utilized for supplementing the user's data collection 110 with relevant recommendations for task completion. As illustrated in FIG. 4A, the list of tasks 404 includes explicitly-specified tasks 410 extracted from the user's data collection 110, such as from a digital notebook 406 created via a notes application 108.

Additionally, the list of tasks 404 may include automatically-suggested tasks 412 based on the context of the data collection 110. For example, based on an identified context or intent that the user is planning a trip to Seattle, the suggestions engine 134 maps the intent to known tasks stored in the tasks repository 130 that are associated with the particular intent (e.g., based on context words), and provides the user with suggested tasks 412 that the user had not explicitly specified. According to an example, the tasks may be chronologically ordered.

Further, the list of tasks 404 may include a list of task providers 408 that have been identified as a provider for task completion for a particular task. As described above, a task provider 408 may be prioritized for a user based at least in part on user data 114. Additionally, links to application associated with the task providers 408, links to URLS associated with the task providers 408, or other contact information may be provided with the list of task providers 408.

In some examples and with reference now to FIG. 4B, the suggestions engine 134 is further operative to provide related interesting information 414 based on an identified entity of the data collection. For example, the system identifies that the user is planning a trip to Seattle (i.e., entity). Accordingly, the suggestions engine 134 queries one or more external data sources 116 for interesting information 414 related to Seattle. Additionally, the system queries one or more external data sources 116 for interesting information 414 associated with related entities. For example and as illustrated, the system may search for popular sightseeing places in Seattle to suggest to the user, and provide the user with information about the suggested places, as well as links to websites associated with the suggestions. According to an aspect, the suggestions engine 134 queries one or more external data sources 116 for related entities based on learned constraints on the data collection 110. For example, it may be determined that the user is planning to do some sightseeing, and has looked up information on some sightseeing places in Seattle that are calm and quiet places, such as parks and museums. Accordingly, the suggestions engine 134 may perform a search for and suggest other calm and quiet places for the user to visit.

With reference now to FIG. 4C, an example activity completion template 416 comprising a collection of suggested tasks 412 and task providers 408 is illustrated. For example, based on a recognized intent or activity of “plan an evening out,” the suggestions engine 134 is operative to map the intent or activity to known tasks stored in the tasks repository 130 that are associated with the particular intent or activity, and provide the user with a template of suggested tasks 412 and task providers 408 for completing the intent or activity.

With reference again to FIG. 1B, the reasoning engine 106 further comprises a collection clusterer 136, illustrative of a software module, system, or device operative to organize a data collection 110. Based on one or more identified entities or intents on a data collection 110, the collection clusterer 136 clusters pieces of content into meaningful groups. For example, if the system determines that a particular data collection 110 has three intents, such as a travel intent, a music intent, and a movie intent, the collection clusterer 136 is operative to automatically determine to which entity cluster a particular piece of data belongs, and sort the information in the data collection 110 into a particular entity cluster based on the determination (e.g., travel-related content is clustered with other travel-related content in a travel intent cluster, music-related content is clustered with other music-related content in a music intent cluster, and movie-related content is clustered with other movie-related content in a movie intent cluster). According to an aspect, an entity cluster may be supplemented with identified related information or suggestions determined by the suggestions engine 134. As can be appreciated, automatically grouping content into logical segments without requiring the user to explicitly organize data reduces manual user steps, and improves user interaction efficiency.

According to an aspect, the reasoning engine 106 further comprises an activity ranker 138, illustrative of a software module, system, or device operative to prioritize tasks for a user, such that content is organized for the user. For example, a user's data collection 110 may comprise data associated with multiple activities or multiple tasks of interest. Accordingly, the activity ranker 138 is operative to understand which tasks may be more important to the user at a particular time, and automatically prioritize those tasks for the user. In one example, the activity ranker 138 orders tasks according to a determined priority. In another example, the activity ranker 138 triggers a reminder to be provided to the user for a prioritized task.

The system is operative to communicate task suggestions, related content, reminders, or clustered data to one or more applications 108 for display or communication to the user. One example of an output canvas includes a productivity application, such as a word processing application, spreadsheet application, or a notes application. Results of the reasoning engine 106 may be pushed to the productivity application, for example, via a plugin, wherein the productivity application is operative to generate a suggestions section comprising task suggestions, related content, reminders, or clustered data, or supplement a data collection 110 with suggestions or related content.

Another example of an output canvas includes an intelligent digital assistant 118, wherein results of the reasoning engine 106 may be communicated with the user. In one example, results, such as a sequence of tasks that are identified as tasks to achieve an activity, may be communicated with the intelligent digital assistant 118 in response to an explicit command from the user. In another example, the intelligent digital assistant 118 may proactively pull results from the reasoning engine 106 upon determination of relevance. For example, the user may have a data collection 110 related to a trip to Seattle. Upon detecting that the user is in Seattle, the intelligent digital assistant 118 may automatically provide relevant content to the user, such as suggested interesting sightseeing places, a weather report, a to-do list related to Seattle created by the user, etc.

Other output canvases may be utilized, such as a browser application. For example and as illustrated in FIG. 4D, the reasoning engine 106 is operative to provide related interesting information 414 and a suggested tasks list 404 based on a search query. For example, the user may perform a search for “nearest volcano to Seattle.” Accordingly, via base entity identification, constraint extraction, and graph walk, the reasoning engine 106 is operative to identify that “Seattle” is a place, and “volcano” is a constraint, and the intent is to find nearby places. Accordingly, in addition to providing information responsive to the search query, one or more external data sources 116 are queried for interesting information 414 related to volcanos near Seattle. Additionally, the system queries one or more external data sources 116 for suggested tasks 412 and task providers 408 associated with the identified entity and related entities.

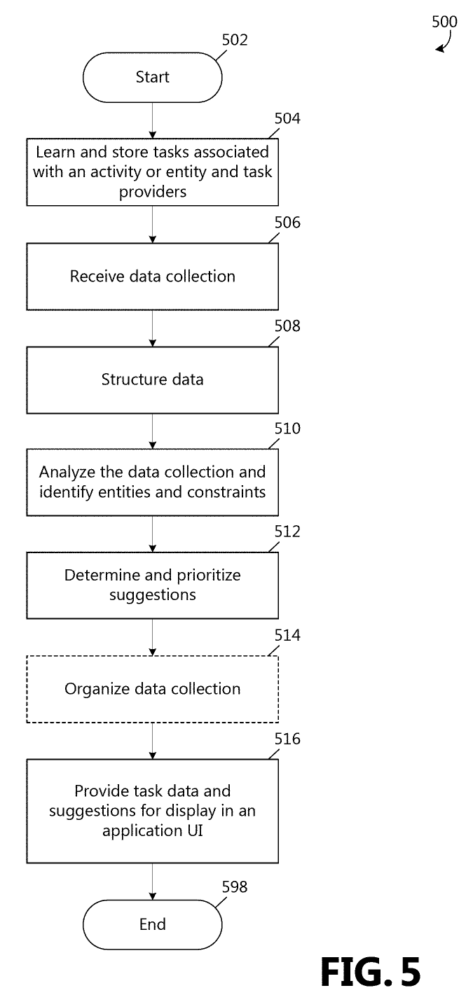

Having described an example operating environment and various examples, FIG. 5 is a flowchart showing general stages involved in an example method 500 for providing automatic enrichment of a data collection 110 with contextually relevant activity/intent suggestions. Method 500 begins at OPERATION 502, and proceeds to OPERATION 504, where one or more external data sources 116 are analyzed for algorithmically identifying tasks 412 related to a context, intent, or activity, and providers 408 of the tasks. According to an example, the reasoning engine 106 applies statistical methods and temporal association rule mining algorithms on external data sources 116, such as browsing histories, search logs, etc. The reasoning engine 106 identifies possible intents on an entity, and learns what tasks people perform. In one example, tasks are learned by seeding with known intents and context words. To find additional tasks, the task extraction and abstraction engine 128 takes the seed known intents, and performs natural language processing and entity detection on queries from search logs. For each task, the task extraction and abstraction engine 128 is operative to find providers 408 for task completion. In one example, the task extraction and abstraction engine 128 identifies task providers 408 via analysis of click data of query logs. Additionally, the task extraction and abstraction engine 128 learns chronological task timelines associated with an activity. In one example, the task extraction and abstraction engine 128 analyzes browsing sessions, and applies temporal association rule mining to understand association rules between tasks and chronological ordering.

The method 500 proceeds to OPERATION 506, where a data collection 110 is received. In one example, the reasoning engine 106 receives a data collection 110 when the data collection is published using a plugin. At OPERATION 508, the data collection 110 is converted into a hierarchical collection, such that inferences can be performed at different hierarchies (e.g., notebook, sections, pages, nodes), and suggestions with a task-centric focus can be pushed to the application 108. According to an aspect, hierarchical collections can be used to transform any data into an abstraction (e.g., notes, emails, browsing history, messages).

The method 500 proceeds to OPERATION 510, where entities of interest are extracted, constraints are learned, and activities intended in the data collection 110 are inferred. In one example, natural language processing is used to extract tasks, subjects, objects, and constraints from natural language data. For example, a to-do item or a query may include “book cheap flight tickets to Seattle.” Accordingly, the system may extract the following data based on trained algorithms and natural language processing: task=“booking;” subject=“flight;” objects=“Seattle;” and constraints=“cheap.”

At OPERATION 512, the system performs a reverse mapping to a known set of tasks and task providers based on algorithmic matching. In some examples, the system prioritizes tasks or task providers based on context or on personal user information 114. Further, the system queries the one or more external data sources 116 for related interesting information and relevant content for task completion. For example, querying for related information may be performed utilizing a search engine, a knowledge graph or a database.

The method 500 proceeds to OPTIONAL OPERATION 514, where, when multiple intents are identified, the system automatically clusters the content into entity or intent-based clusters, thus organizing unorganized content.

At OPERATION 516, the system provides task data and suggestions for display in an application UI 104. In one example, the results of the reasoning engine 106 are communicated to an application 108, and added to a document as an automatically generated section. In another example, activity/intent suggestions are aggregated with the user's explicitly-specified tasks (e.g., from the user's notes, browsing history), and are displayed in an application UI 104. The method 500 ends at OPERATION 598.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 6-8 and the associated descriptions provide a discussion of a variety of operating environments in which examples are practiced. However, the devices and systems illustrated and discussed with respect to FIGS. 6-8 are for purposes of example and illustration and are not limiting of a vast number of computing device configurations that are utilized for practicing aspects, described herein.

FIG. 6 is a block diagram illustrating physical components (i.e., hardware) of a computing device 600 with which examples of the present disclosure may be practiced. In a basic configuration, the computing device 600 includes at least one processing unit 602 and a system memory 604. According to an aspect, depending on the configuration and type of computing device, the system memory 604 comprises, but is not limited to, volatile storage (e.g., random access memory), non-volatile storage (e.g., read-only memory), flash memory, or any combination of such memories. According to an aspect, the system memory 604 includes an operating system 605 and one or more program modules 606 suitable for running software applications 650. According to an aspect, the system memory 604 includes a reasoning engine 106, operative to enable a software application 650 to employ the teachings of the present disclosure via stored instructions. The operating system 605, for example, is suitable for controlling the operation of the computing device 600. Furthermore, aspects are practiced in conjunction with a graphics library, other operating systems, or any other application program, and is not limited to any particular application or system. This basic configuration is illustrated in FIG. 6 by those components within a dashed line 608. According to an aspect, the computing device 600 has additional features or functionality. For example, according to an aspect, the computing device 600 includes additional data storage devices (removable and/or non-removable) such as, for example, magnetic disks, optical disks, or tape. Such additional storage is illustrated in FIG. 6 by a removable storage device 609 and a non-removable storage device 610.

As stated above, according to an aspect, a number of program modules and data files are stored in the system memory 604. While executing on the processing unit 602, the program modules 606 (e.g., reasoning engine 106) perform processes including, but not limited to, one or more of the stages of the method 500 illustrated in FIG. 5. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, the computing device 600 has one or more input device(s) 612 such as a keyboard, a mouse, a pen, a sound input device, a touch input device, etc. The output device(s) 614 such as a display, speakers, a printer, etc. are also included according to an aspect. The aforementioned devices are examples and others may be used. According to an aspect, the computing device 600 includes one or more communication connections 616 allowing communications with other computing devices 618. Examples of suitable communication connections 616 include, but are not limited to, radio frequency (RF) transmitter, receiver, and/or transceiver circuitry; universal serial bus (USB), parallel, and/or serial ports.

The term computer readable media, as used herein, includes computer storage media apparatuses and articles of manufacture. Computer storage media include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (i.e., memory storage). According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. According to an aspect, any such computer storage media is part of the computing device 600. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

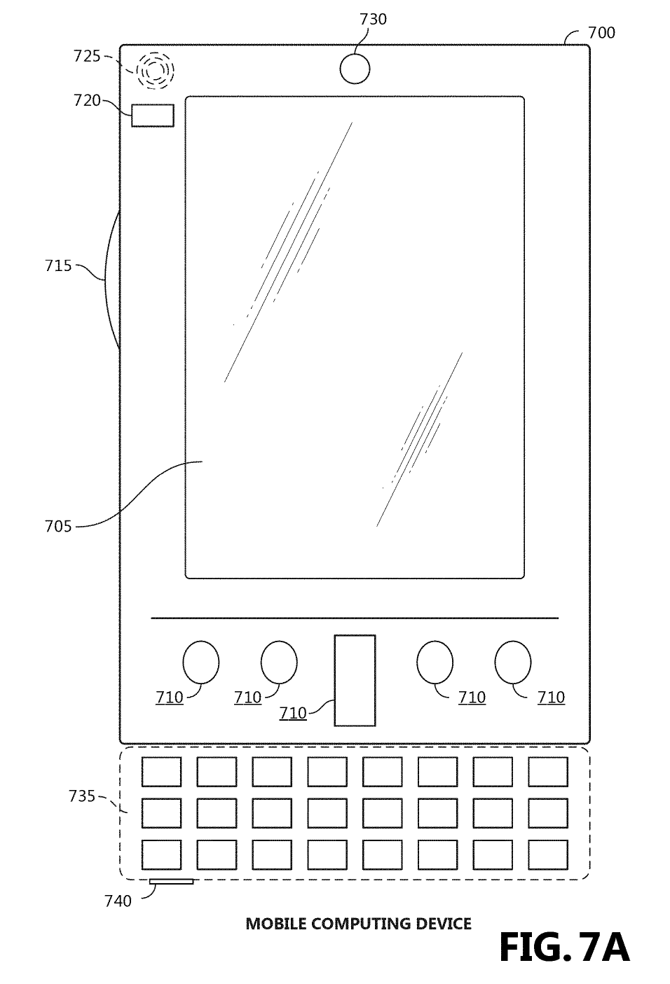

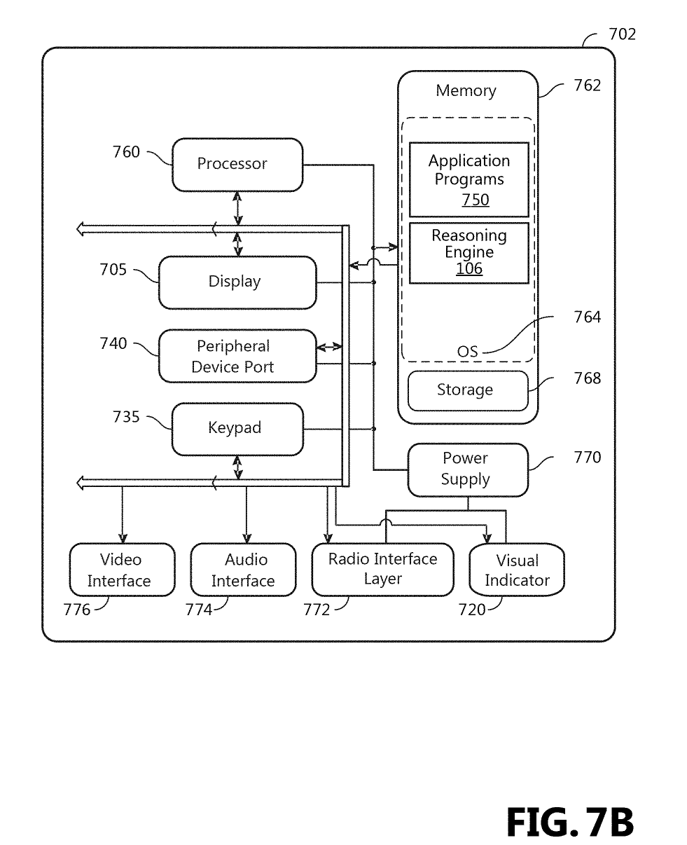

FIGS. 7A and 7B illustrate a mobile computing device 700, for example, a mobile telephone, a smart phone, a tablet personal computer, a laptop computer, and the like, with which aspects may be practiced. With reference to FIG. 7A, an example of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. According to an aspect, the display 705 of the mobile computing device 700 functions as an input device (e.g., a touch screen display). If included, an optional side input element 715 allows further user input. According to an aspect, the side input element 715 is a rotary switch, a button, or any other type of manual input element. In alternative examples, mobile computing device 700 incorporates more or fewer input elements. For example, the display 705 may not be a touch screen in some examples. In alternative examples, the mobile computing device 700 is a portable phone system, such as a cellular phone. According to an aspect, the mobile computing device 700 includes an optional keypad 735. According to an aspect, the optional keypad 735 is a physical keypad. According to another aspect, the optional keypad 735 is a “soft” keypad generated on the touch screen display. In various aspects, the output elements include the display 705 for showing a graphical user interface (GUI), a visual indicator 720 (e.g., a light emitting diode), and/or an audio transducer 725 (e.g., a speaker). In some examples, the mobile computing device 700 incorporates a vibration transducer for providing the user with tactile feedback. In yet another example, the mobile computing device 700 incorporates a peripheral device port 740, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one example of a mobile computing device. That is, the mobile computing device 700 incorporates a system (i.e., an architecture) 702 to implement some examples. In one example, the system 702 is implemented as a “smart phone” capable of running one or more applications (e.g., browser, e-mail, calendaring, contact managers, messaging clients, games, and media clients/players). In some examples, the system 702 is integrated as a computing device, such as an integrated personal digital assistant (PDA) and wireless phone.

According to an aspect, one or more application programs 750 are loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. According to an aspect, the reasoning engine 106 is loaded into memory 762. The system 702 also includes a non-volatile storage area 768 within the memory 762. The non-volatile storage area 768 is used to store persistent information that should not be lost if the system 702 is powered down. The application programs 750 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700.

According to an aspect, the system 702 has a power supply 770, which is implemented as one or more batteries. According to an aspect, the power supply 770 further includes an external power source, such as an AC adapter or a powered docking cradle that supplements or recharges the batteries.

According to an aspect, the system 702 includes a radio 772 that performs the function of transmitting and receiving radio frequency communications. The radio 772 facilitates wireless connectivity between the system 702 and the “outside world,” via a communications carrier or service provider. Transmissions to and from the radio 772 are conducted under control of the operating system 764. In other words, communications received by the radio 772 may be disseminated to the application programs 750 via the operating system 764, and vice versa.

According to an aspect, the visual indicator 720 is used to provide visual notifications and/or an audio interface 774 is used for producing audible notifications via the audio transducer 725. In the illustrated example, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. According to an aspect, the system 702 further includes a video interface 776 that enables an operation of an on-board camera 730 to record still images, video stream, and the like.

According to an aspect, a mobile computing device 700 implementing the system 702 has additional features or functionality. For example, the mobile computing device 700 includes additional data storage devices (removable and/or non-removable) such as, magnetic disks, optical disks, or tape. Such additional storage is illustrated in FIG. 7B by the non-volatile storage area 768.

According to an aspect, data/information generated or captured by the mobile computing device 700 and stored via the system 702 are stored locally on the mobile computing device 700, as described above. According to another aspect, the data are stored on any number of storage media that are accessible by the device via the radio 772 or via a wired connection between the mobile computing device 700 and a separate computing device associated with the mobile computing device 700, for example, a server computer in a distributed computing network, such as the Internet. As should be appreciated, such data/information are accessible via the mobile computing device 700 via the radio 772 or via a distributed computing network. Similarly, according to an aspect, such data/information are readily transferred between computing devices for storage and use according to well-known data/information transfer and storage means, including electronic mail and collaborative data/information sharing systems.

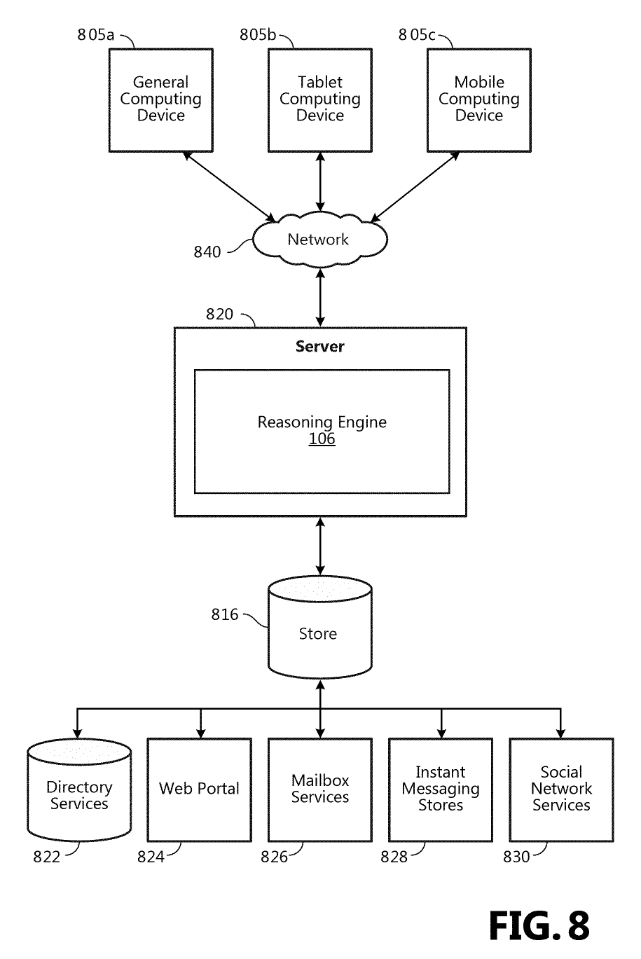

FIG. 8 illustrates one example of the architecture of a system for automatic presentation of blocks of repeated content as described above. Content developed, interacted with, or edited in association with the reasoning engine 106 is enabled to be stored in different communication channels or other storage types. For example, various documents may be stored using a directory service 822, a web portal 824, a mailbox service 826, an instant messaging store 828, or a social networking site 830. The reasoning engine 106 is operative to use any of these types of systems or the like for providing automatic enrichment of a data collection with contextually relevant activity/intent suggestions, as described herein. According to an aspect, a server 820 provides the reasoning engine 106 to clients 805a-c (generally clients 805). As one example, the server 820 is a web server providing the reasoning engine 106 over the web. The server 820 provides the reasoning engine 106 over the web to clients 805 through a network 840. By way of example, the client computing device is implemented and embodied in a personal computer 805a, a tablet computing device 805b or a mobile computing device 805c (e.g., a smart phone), or other computing device. Any of these examples of the client computing device are operable to obtain content from the store 816.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the present disclosure.

We claim:

1. A method for providing automatic enrichment of a data collection associated with a user with contextually relevant activity/intent suggestions for task completion, comprising:
receiving a data collection;
identifying an intent associated with the data collection;
mapping the identified intent to a known set of tasks; and
displaying the set of tasks as suggestions to the user in an application user interface.

2. The method of claim 1, wherein identifying at least one intent associated with the data collection comprises:
using natural language processing on the data collection to extract at least one of:
tasks;
subjects;
objects; and
constraints; and
based on the extracted information, identifying an entity and an intent.

3. The method of claim 1, wherein prior to mapping the identified intent to a known set of tasks, analyzing one or more external data sources for identifying one or more tasks performed on an entity for a given intent.

4. The method of claim 3, wherein identifying one or more tasks performed on an entity for a given intent comprises extracting a task timeline for performing the one or more tasks.

5. The method of claim 3, wherein analyzing one or more external data sources for one or more tasks performed on an entity for a given intent comprises performing natural language processing and entity detection on queries from search logs or browsing histories.

6. The method of claim 5, wherein performing entity detection on queries from search logs or browsing histories comprises performing entity detection on queries from search logs or browsing histories associated with the user or community search logs or browsing histories associated with a plurality of users.

7. The method of claim 3, further comprising analyzing one or more external data sources for determining one or more task providers for completion of each task.

8. The method of claim 7, further comprising prioritizing one or more tasks of the set of tasks or at least one task provider for completion of each task based on at least one of:
user data; and
community information.

9. The method of claim 8, wherein displaying the set of tasks as suggestions to the user in the application user interface comprises:
identifying context data;
determining a set of tasks that are contextually relevant to the user based on the context data; and
displaying the set of tasks and a task provider for each task.

10. The method of claim 1, further comprising:
querying one or more data sources for results that relate to the intent;
identifying constraints associated with the data collection;
parsing the results in view of the constraints; and
displaying the results as suggested related content in the application user interface.

11. The method of claim 1, wherein identifying an intent associated with the data collection comprises:
identifying a plurality of intents; and
automatically organizing data in the data collection according to an identified intent.

12. A computing device for providing automatic enrichment of a data collection associated with a user with contextually relevant activity/intent suggestions for task completion, comprising:
a processing unit; and
a memory, including computer readable instructions, which when executed by the processing unit is operable to:
analyze one or more external data sources for identifying one or more tasks performed on an entity for a given intent;
store the identified tasks as a known set of tasks associated with a given intent;
analyze one or more external data sources for identifying one or more task providers for completion of each task;
store the identified task providers;
receive a data collection;
identify an intent associated with the data collection;
map the identified intent to the known set of tasks; and
display the set of tasks as suggestions to the user in an application user interface.

13. The computing device of claim 12, wherein in analyzing one or more external data sources for one or more tasks performed on an entity for a given intent, the computing device is operative to perform natural language processing and entity detection on queries from at least one of:
the user's search logs or browsing histories; and
community search logs or browsing histories associated with a plurality of users.

14. The computing device of claim 12, wherein the computing device is further operative to:
prioritize at least one task provider for completion of each task based on user data; and
display the at least one task provider with the task.

15. The computing device of claim 12, wherein the computing device is further operative to:
query one or more data sources for results that relate to the intent;
identify constraints associated with the data collection;
parse the results in view of the constraints; and
display the results as suggested related content in the application user interface.

16. The computing device of claim 12, wherein in identifying an intent associated with the data collection, the computing device is operative to:
identify a plurality of intents; and
automatically organize data in the data collection according to an identified intent.

17. The computing device of claim 12, wherein the data collection includes at least one of:
notes;
to-do items;
uniform resource locators;
browsing history data; and
messages.

18. A computer readable storage device including computer readable instructions, which when executed by a processing unit is operable to:
analyze one or more external data sources for identifying one or more tasks performed on an entity for a given intent;
analyze one or more external data sources for identifying one or more task providers for completion of each task;
link the one or more task providers to a task;
store the identified tasks and linked task providers as a known set of tasks and task providers associated with a given intent;
receive a data collection associated with a user;
convert the data collection into a hierarchical collection;
identify an intent associated with the hierarchical collection;
map the identified intent to the known set of tasks;
prioritize at least one task provider for completion of each task based on user data or community data; and
display the set of tasks and prioritized task providers as suggestions to the user in an application user interface.

19. The computer readable storage device of claim 18, further operative to:
query one or more data sources for results that relate to the intent;
identify constraints associated with the data collection;
parse the results in view of the constraints; and
display the results as suggested related content in the application user interface.

20. The computer readable storage device of claim 18, wherein in displaying the set of tasks and prioritized task providers as suggestions to the user in an application user interface, the device is further operative to:
identify context data;
determine a set of tasks that are contextually relevant to the user based on the context data; and
display the set of tasks and a task provider for each task.
